(19) United States
(12) Patent Application Publication
(10) Pub. No.: US 2005/0120195 A1
(43) Pub. Date: Jun. 2, 2005

(54) Allocating memory

(76) Inventor: Alok Kumar, Santa Clara, CA (US)

Correspondence Address: FISH & RICHARDSON, PC, 12390 EL CAMINO REAL, SAN DIEGO, CA, 92130-2081, US

(21) Appl. No.: 10/713,776

(22) Filed: Nov. 13, 2003

(51) Int. Cl. G06F 9/00; G06F 15/00; G06F 15/76

(52) U.S. Cl. 712/245; 711/108

(57) ABSTRACT

A method includes allocating a memory entry in a memory device to instructions executed on a multithreaded engine included in a packet processor, a portion of the memory entry includes a unique identifier assigned to the instructions.

### BACKGROUND

Networks are used to distribute information among computer systems by sending the information in segments such as packets. A packet typically includes a “header”, which is used to direct the packet through the network to a destination. The packet also includes a “payload” that stores a portion of information being sent through the network. To use the payload of each packet, processors such as microprocessors, central processing units (CPU's), and the like execute instructions to read and store the packets in memory for processing. As memory is filled with packets, some stored packets are removed to conserve memory space. Typically, stored packets that are less frequently accessed are chosen for removal for conserving memory space.

### DESCRIPTION OF DRAWINGS

FIG. 1 is a block diagram depicting a system for processing packets.

FIG. 2 is a block diagram depicting a network processor.

FIG. 3 is a block diagram depicting portions of a network processor packet engine.

FIGS. 4A-C are block diagrams depicting variables and a status register used by a network processor packet engine.

FIG. 5 is a flow chart of a portion of a memory manager.

FIG. 6 is a flow chart of another portion of a memory manager.

### DESCRIPTION

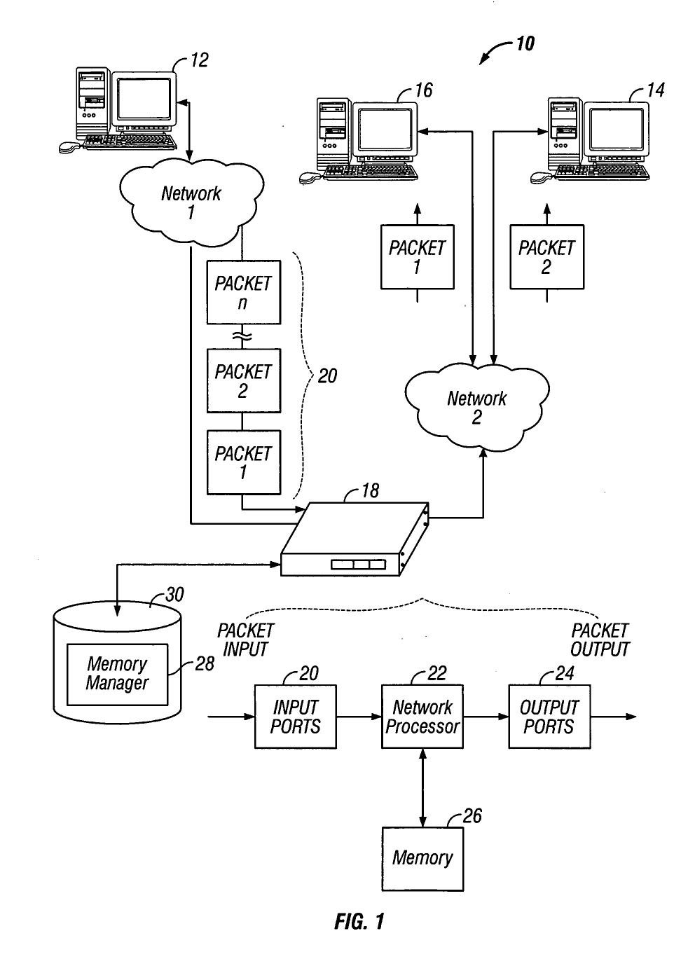

Referring to FIG. 1, a system 10 for transmitting packets from a computer system 12 through a network 1 (e.g., a local area network (LAN), a wide area network (WAN), etc.) to other computer systems 14, 16 by way of another network 2 includes a router 18 that collects a stream of “n” packets 20 and schedules delivery to the appropriate destinations of the individual packets as provided by information included in the packets. For example, information stored in the “header” of packet 1 is used by the router 18 to send the packet through network 2 to computer system 16 while “header” information in packet 2 is used to send packet 2 to computer system 14.

Typically, the packets are received by the router 18 on one or more input ports 20 that provide a physical link to network 1. The input ports 20 are in communication with a network processor 22 that controls the entering of the incoming packets. The network processor 22 also communicates with router output ports 24, which are used for scheduling transmission of the packets through network 2 for delivery at one or more appropriate destinations e.g., computer systems 14, 16. In this particular example, the router 18 uses the network processor 22 to send the stream of “n” packets 20, however, in other arrangements a hub, switch, of other similar network forwarding device that includes a network processor is used to transmit the packets.

Typically, as the packets are received, the router 18 stores the packets in a memory 26 (e.g., a dynamic random access memory (DRAM), etc.) that is in communication with the network processor 22. By storing the packets in the memory 26, the network processor 22 accesses the memory to retrieve one or more packets, for example, to verify if a packet has been lost in transmission through network 1, or to determine packet destinations, or to perform other processing. To process the packets, a memory manager 28 is executed on the network processor 22 that monitors memory included in the network processor and determines if portions of the memory are ready to store received packets or other data used by the network processor.

In this particular example, the memory manager 28 is stored on a storage device 30 (e.g., a hard drive, CR-ROM, etc.) that is in communication with router 18. However, in other arrangements the memory manager 28 resides in a memory (e.g., RAM, ROM, SRAM, DRAM, etc.) that is included e.g., in the router 18 such as memory 26 or in memory internal to the network processor 22.

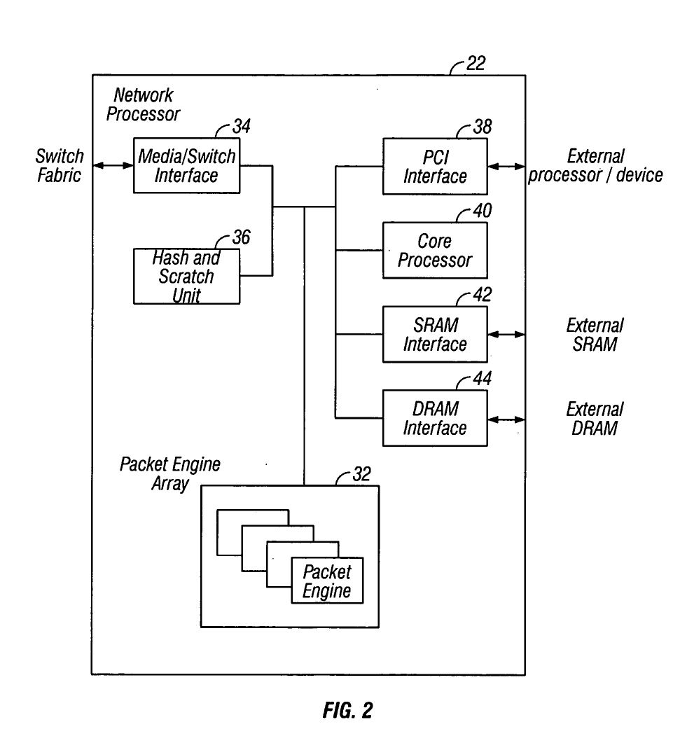

Referring to FIG. 2, the network processor 22 is depicted to include features of an Intel® Internet exchange network processor (IXP). However, in some arrangements the network processor 22 incorporates other network processor designs. This exemplary network processor 22 includes an array of packet engines 32 in which each engine provides multi-threading capability for executing instructions from an instruction set such as a reduced instruction set computing (RISC) architecture. For example, for efficient processing RISC instructions may not include floating point instructions or instructions for integer multiplication or division commonly provided by general purpose processors. Furthermore, since the instruction set is designed for specific use by the array of packet engines 32, the instructions are executed relatively quickly, for example, compared to instructions executing on a general-purpose processor.

Each packet engine included in the array 32 also includes e.g., eight threads that interleave instruction executing that increases efficiency and makes more productive use of the packet engine resources that might otherwise be idle. In some arrangements, the multi-threading capability of the packet engine array 32 is supported by hardware that reserves different registers for different threads and quickly swaps thread contexts. In addition to accessing shared memory, each packet engine also features local memory and a content-addressable memory (CAM). The packet engines may communicate among each other, for example, by using neighbor registers in communication with an adjacent engine or engines or by using shared memory space.

The network processor 22 also includes a media/switch interface 34 (e.g., a CSIX interface) that sends and receives data to and from devices connected to the network processor such as physical or link layer devices, a switch fabric, or other processors or circuitry. A hash and scratch unit 36 is also included in the network processor 22. The hash function provides, for example, the capability to perform polynomial division (e.g., 48-bit, 64-bit, 128-bit, etc.) in hardware to conserve clock cycles that are typically needed in a software implemented hash function. The hash and scratch unit 36 also includes memory such as static random access memory (SRAM) that provides a scratchpad function while operating relatively quickly compared to SRAM external to the network processor 22.

The network processor 22 also includes a interface 38 (e.g., a peripheral component interconnect (PCI) interface) for communicating with another processor such as a microprocessor (e.g. Intel Pentium®, etc.) or to provide an interface to an external device such as a public-key cryptosystem (e.g., a public-key accelerator) to transfer data to and from the network processor 22 or external memory (e.g., SRAM, DRAM, etc.) in communication with the network processor such as memory 26. A core processor 40 such as a StrongARM® Xscale® processor from ARM Limited of the United Kingdom is also included in the network processor 22. The core processor 40 typically performs “control plane” tasks and management tasks (e.g., look-up table maintenance). However, in some arrangements the core processor 40 also performs “data plane” tasks, which are typically performed by the packet engine array 32 and may provide additional packet processing threads.

The network processor 22 also includes an SRAM interface 42 that controls read and write access to external SRAMs along with modified read/write operations (e.g., increment, decrement, add, subtract, bit-set, bit-clear, swap, etc.), link-list queue operations, and circular buffer operations. A DRAM interface 44 controls DRAM external to the network processor 22, such as memory 26, by providing hardware interleaving of DRAM address space to prevent extensive use of particular portions of memory.

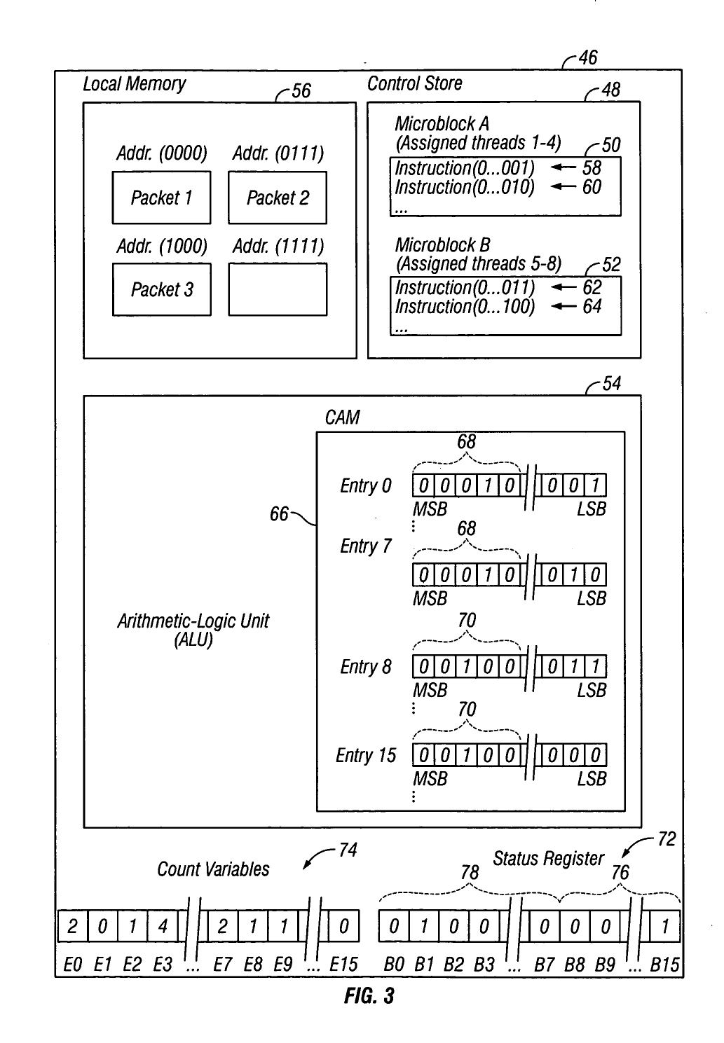

Referring to FIG. 3, a packet engine 46 included in the array of packet engines 32 is implemented with a relatively simple architecture that quickly executes processes such as packet verifying, packet classifying, packet forwarding, and so forth, while leaving more complicated processing to the core processor 40. The packet engine 46 includes multiple threads that interleave the execution of instructions. In this example, the packet engine 46 includes eight threads, however, in other arrangements the packet engine may include more or less threads. When a thread is executing instructions, and experiences a break point, i.e., a break in processing that would incur a relatively large latency before resuming execution, such as the need to perform a memory access, another thread included in the packet engine executes instructions to maintain a nearly constant number of instructions executed per second on the packet engine 46.

Instructions executed on the packet engine 46 are typically written in code designed for the network processor 22 and the code is typically referred to as microcode. However, in some arrangements, high-level languages such as “C”, “C++”, or other similar computer languages are used to program instructions for execution on the packet engine 46. In this particular example, a control store 48 included in the packet engine 46 stores two executable blocks of microcode that are typically referred to as microblocks 50, 52. Each of the microblocks 50, 52 include microcode instructions that are executed on the packet engine 46 for performing particular processes. Typically, the control store 48 includes dedicated memory (e.g., RAM, ROM, etc.) that provides local storage of the microblocks 50, 52 on the packet processor 46. Furthermore, memory manager 28 is typically stored in control store 46 for executing on the packet engine 46.

To execute the instructions included in each microblock 50, 52, the packet engine 46 allocates the eight threads between the microblocks. For example, by uniformly distributing the threads, four threads (e.g., threads 1-4) are assigned to execute microblock 50 and the other four threads (e.g., threads 5-8) are assigned to execute microblock 52. However, in some arrangements the eight threads may be unevenly distributed between the microblocks. For example, a microblock that includes a relatively large number of memory accessing instructions is assigned more threads than another microblock that includes less memory accessing instructions.

The packet engine 46 also includes an arithmetic-logic unit (ALU) 54 that carries out arithmetic and logic operations as the microblock instructions are executed. In some arrangements the ALU 54 is divided into two units, an arithmetic unit (AU) that executes arithmetic operations (e.g., addition, subtraction, etc.) and a logic unit (LU) that executes logical operations (e.g., logical AND, logical OR, etc.).

Typically, when executing a microblock instruction, the ALU 54 accesses data identified by one or more operands included with the instruction. In this arrangement, the instruction operands identify packets received by the router 18 and stored in a local memory 56 included in the packet engine 46. For example, received packet 1 is stored at one local memory 56 location (i.e., address 0000) while packet 2 and packet 3 are stored at other respective local memory locations (i.e., address 0111, address 1000). In this example, portions of the local memory 56 store received packets, however, in other arrangements, the local memory stores other types of data.

To process the packets received by the router 18 with the microblock instructions, the memory manager 28 determines if the packets needed for processing are being stored in the local memory 56. Typically, the determination occurs when the packet engine 46 executes a microblock instruction. For example, when instruction 58 is executed, the memory manager 28 uses the instruction's operand to determine if the packet identified by the operand is present in the local memory 56 of the packet engine 46 or needs to be loaded. In this example, the operand of instruction 58 includes the binary equivalent of decimal number 1 (i.e., 0 . . . 001) that identifies packet 1 as being used with the instruction. Similarly, the operands of instructions 60, 62, and 64 include respective binary equivalents (i.e., 0 . . . 010, 0 . . . 011, 0 . . . 100) to identify packets 2, 3, and 4. In this example, the operands of each instruction include a binary number to identify a particular packet, however, in other arrangements one or more of the operands identify a group of packets, a series of packets, or other combination of packets or other type of data.

To relatively quickly determine if a particular packet is present in the local memory 56, the memory manager 28 uses a content-addressable-memory 66 (CAM) included in the ALU 54. The CAM 66 includes e.g., sixteen 32-bit entries (i.e., entry 0-entry 15) that are capable of being used by the eight threads respectively assigned to the microblocks 50, 52. Typically the CAM 66 allows the entries to be accessed in parallel so that all or some of the entries can be checked during the same time period (e.g., clock cycle) to determine if particular data is present in one of the entries. For example, data stored in the entries can be compared in parallel to data included in an instruction operand to determine if a match is present. If a match is detected, the CAM entry storing the matching data is used to identify a corresponding location in local memory 56. In some arrangements, the CAM entry that produces the match identifies the local memory address similar to a “pointer”. For example, the operand of instruction 58 includes the binary number (i.e., 0 . . . 001) to identify packet 1. To determine if and in which local memory location packet 1 is stored, the memory manager 28 compares the binary number in the operand to the data stored in the CAM entries. If a match is found, the matching CAM entry is used by memory manager 28 to find the corresponding location in local memory 56. If a match is not found, the memory manager 28 determines which CAM entry to use to identify a local memory location that can be used for storing packet 1. For example, the memory manager 28 may identify one of the CAM entries not currently being used by a thread to identify a local memory location for storing packet 1.

In some arrangements to access and use the CAM entries, the memory manager 28 and/or the microblocks 50, 52 use application program interfaces (API). For example, an API is used to find a CAM entry being used by a microblock and is implemented as:
Cam_lookup(out dest_reg, in dl_micro_CAM_handle, in src_reg).

In another example, another exemplary API is used to determine if a CAM entry is available for use and is implemented as:
Cam_find_free_entry(out dest_reg, in dl_micro CAM_handle, in lookup_result).

Also, in another operation, to release a CAM entry from being used by a microblock and a corresponding thread, another exemplary executable API is implemented as:
Cam_exit_using_entry(in dl_micro_CAM_handle, in cam_entry).

In some arrangements, microblock 50 executes on the packet engine 46 relatively faster than microblock 52. In such an arrangement, by executing faster, microblock 50 may use more CAM entries to identify needed packets stored in the local memory 56. Since less CAM entries are available to the slower executing microblock 52, accessing needed packets for the slower microblock is correspondingly slower. Additionally, if microblock 50 needs additional CAM entries to identify more packets in local memory 56, and since the CAM entries used by slower executing microblock 52 may appear to be less frequently accessed, microblock 50 may begin using these CAM entries and reduce the number of entries used by microblock 52.

To assure that each microblock 50, 52 is provided CAM entries for accessing packets in the local memory 56, the CAM entries are uniformly distributed between the microblocks. In this example, since two microblocks 50, 52 are executed by the packet engine 46, eight of the sixteen CAM entries (e.g., entries 0-7) are assigned to microblock 50 and the other eight CAM entries (e.g., entries 8-15) are assigned to microblock 52. By distributing the CAM entries between the microblocks, the slower executing microblock 52 has eight dedicated CAM entries to use to access the local memory 56 that the relatively quicker executing microcode 50 does not eventfully gain control of due to quicker execution. Also, by distributing the CAM entries between the microblocks 50, 52, the CAM 66 along with the local memory 56 is efficiently used by the packet engine 46 to execute both microblocks.

In this arrangement, the CAM 66 entries are allocated between the microblocks 50, 52 by assigning a unique four-bit key to each microblock and including the unique key in the CAM entries assigned to the respective microblocks. However, in some arrangements the unique keys include more than or less than four bits. In this example, a unique key 68 assigned to microblock 50 is the four-bit binary equivalent of decimal number 1 (i.e., 0001) and is included in the four most significant bits (MSB) of the first eight CAM entries (i.e., entry 0-entry 7). Similarly, a unique key 70 is also assigned to microblock 52, however, this unique key is the four-bit binary equivalent of decimal number 2 (i.e., 0010) and is included in the four MSB's of the other eight CAM entries (i.e., entry 8-entry 15). In this example, each CAM entry has is thirty-two bits long, so by respectively including a four-bit key in each entry, twenty-eight bits are used for matching the instruction operands included in the respective microblocks 50, 52. However, in some arrangements CAM entries include more or less bits, and furthermore the CAM may include more or less than sixteen entries.

Since each CAM entry includes a four-bit key uniquely assigned to each microblock 50, 52; to match an instruction operand, the key along with the operand needs to be matched. For example, while executing instruction 58, due to the unique key 68 assigned to microblock 50, the memory manager 28 compares the instruction's operand to CAM entries 0-7. In this example, the contents of CAM entry 0 matches the unique key 68 assigned to microblock 50 and the operand of instruction 58. Since a match is found, the memory manager 28 uses CAM entry 0 to identify the local memory location (i.e., address 0000) that stores packet 1. In this particular example, the binary equivalent (i.e., 0000) of the matching CAM entry's number (i.e., entry “0”) identifies an address in the location memory 56 (i.e., address 0000) in which packet 1 is stored.

If a match is not found, the memory manager 28 determines the particular CAM entry associated with the microblock that includes the executed instruction to store data for providing a match. For example, when instruction 64 is executed, the memory manager 28 compares the four-bit key (i.e., 0010) assigned to microblock 52 and the instruction operand (i.e., 0 . . . 100) with the eight CAM entries (i.e., entries 8-15) assigned to the microblock 52. In this example, none of the eight CAM entries include contents that match the key and the operand of instruction 64. Since no match is found, the memory manager 28 determines which of the eight CAM entries (i.e., entry 8-15) assigned to microblock 52 is available to identify a local memory location for storing the packet (i.e., packet 4) identified by the operand.

To determine if one or more of the CAM entries are available, the memory manager 28 monitors a status register 72 included in the packet engine 46 that indicates CAM entry availability by respectively assigning a bit included in the register to each CAM entry. In this example, bit B0 through bit B15 are respectively assigned to CAM entry 0 through CAM entry 15. To indicate availability, a bit is set to a logic level “1” when no threads included in the packet engine 46 are using the corresponding CAM entry. For example, bits B2 and B15 are set to logic level “1” to indicate that CAM entries 2 and 15 are available to identify a packet or other data stored in the local memory 56.

To determine whether to set a particular bit in the status register 72 to logic level “1”, the memory manager 28 determines if one or more of the threads assigned to the respective microblock are using the CAM entries allocated to the microblock. For example, the memory manager 28 determines if CAM entries 0-7, which are assigned to microblock 50, are individually being used by one or more of the threads (i.e., threads 1-4) assigned to the microblock. Similarly, to determine if the CAM entries (i.e., entries 8-15) assigned microblock 52 are available, the memory manager 28 determines if one or more of the assigned threads 5-8 are individually using these CAM entries. By not allowing a CAM entry to be available, unless no thread is using the entry, the probability that a CAM entry is cleared of data, while still being used by a thread, is reduced.

To determine whether to set one or more of the bits in the status register 72 to indicate that no thread is using the corresponding CAM entry, the memory manager 28 maintains a count of each thread using each CAM entry. In this particular example a group of variables 74 respectfully store the number of threads using the CAM entries. Here, variables E0 through E15 store the number of threads respectively using CAM entries 0 through 15. In this example, variable E0 reports that 2 threads are currently using CAM entry 0. Also, since variable E1 stores a value of “0”, no threads are currently using CAM entry 1 and accordingly the bit B1 is set to logic level “1”. Similarly, variable E15 reports that no threads are using CAM entry 15 and bit B15 is set to a logic level “1”. By tracking the number of threads currently using each CAM entry, the memory manager 28 is capable of determining the status of each CAM entry by checking the status register 72 and not monitoring the accessing of the individual CAM entries. Furthermore, since the CAM entries are allocated between the two microblocks 50, 52, the memory manager 28 determines if the CAM entries assigned to one microblock are being used by one or more threads by checking a portion of the status register 72 and not all of the bits included in the register. For example, to determine if one or more of the CAM entries (e.g., entries 0-7) assigned to microblock 50 are being used by one or more threads, the memory manager 28 performs a logical “AND” operation to mask the status register bits 76 associated with microblock 52 so that only the bits 78 associated with microblock 50 are used to determine the available CAM entries.

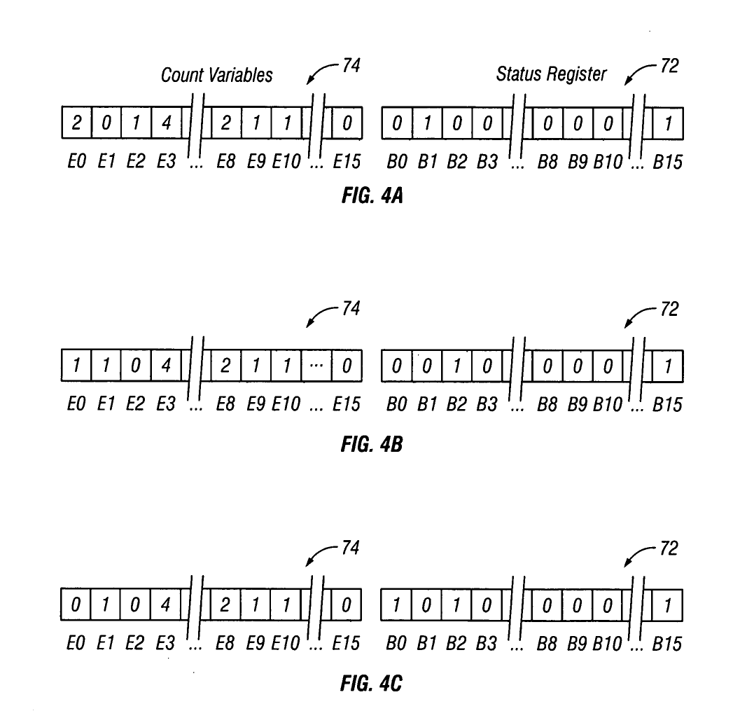

Referring to FIG. 4A-C, as threads use and stop using the CAM entries, values stored in the count variables 74 and the status register 72 corresponding vary.

Referring to FIG. 4A, the contents of the count variables 74 report that CAM entries 1 and 15 are not being used while CAM entries 0 and 2-14 are being used by one or more threads. Accordingly, bit B1 and B15 in the status register 72 are set to logic level “1” to indicate that CAM entries 1 and 15 are available to the respectively assigned threads (e.g., threads 1-4 for CAM entry 1, and 5-8 threads for CAM entry 15).

Referring to FIG. 4B, after a particular time period or number of clock cycles, the memory manager 28 polls the number of threads using each CAM entry. In this particular example, one less thread (e.g., thread 1) is no longer using CAM entry 0 to identify a packet stored in local memory 56, accordingly, the memory manager 28 decrements the value stored in the variable E0 by 1 (i.e., from value “2” to value “1”). In a similar fashion, the memory manager 28 also decrements the variable E2 by 1 to represent that one less thread is using CAM entry 2. In this example, since no threads are now using CAM entry 2, as represented by variable E2, the appropriate bit (i.e., bit B2) in the status register 72 is set to a logic level “1”. Alternatively, one thread assigned to microblock 50 begins using CAM entry 1 and the memory manager 28 increments the value stored in variable E1 by 1. Accordingly, since one thread is now using CAM entry 1, logic “0” is entered into the appropriate bit (i.e., bit B1) in the status register 72.

Referring to FIG. 4C, after another period of time of one or more clock cycles, the memory manager 28 again determines the number of threads using each individual CAM entry. In this example, the thread (e.g., thread 1) that was using CAM entry 0 as represented in FIG. 4B, halts using the entry CAM and the memory manager 28 decrements the value held by variable E0 to decimal number 0. Correspondingly, bit B0 is set to a logic level “1” to represent that CAM entry 0 is not being used by any threads and is available for a thread assigned to microblock 50 (e.g., thread 1-4).

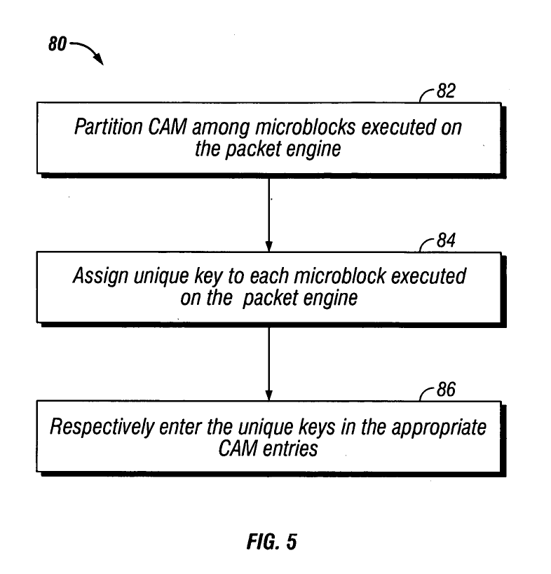

Referring to FIG. 5 an example of a portion of a memory manager 80 includes partitioning 82 the CAM 66 such that the CAM entries are allocated among the microblocks executed on the packet engine 46. For example, the CAM entries may be uniformly allocated among the microblocks. Alternatively, the CAM entries may be allocated based on instructions included in the microblocks. For example, a microblock that includes a relatively large amount of local memory access instructions (e.g., read instructions, write instructions, etc.) is allocated a larger partition of CAM entries. Furthermore, instead of using a uniform distribution, another distribution such as a normal distribution is used to partition the CAM among the microblocks. The memory manager 80 also includes assigning 84 a unique key to each microblock executed on the packet engine 46. For example, as shown in FIG. 3, microblock 50 is assigned the unique key 68 that is the four-bit binary equivalent of the decimal number 1 while microblock 52 is assigned another key 70 that the four-bit binary equivalent of the decimal number 2. After the unique key is assigned to each microblock executed by the packet engine 46, the memory manager 80 respectively enters 86 the unique keys in the appropriate CAM entries within the partitions. For example, as shown in FIG. 3, the four-bit keys 68, 70 are respectively entered into the MSB's of the CAM entries 0-15.

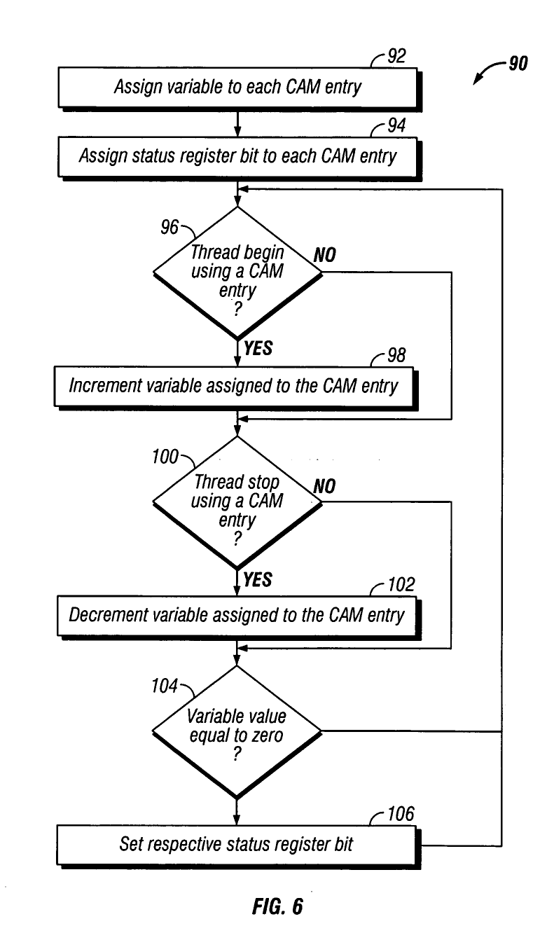

Referring to FIG. 6, an example of a portion of a memory manager 90 includes assigning 92 a variable to each CAM entry for maintaining a count of the number of threads using the associated CAM entry. The memory manager 90 also includes assigning 94 a bit included in a status register, such as the status register 72, to each respective CAM entry. By assigning each CAM entry to a bit, the memory manager 90 can relatively quickly determine if one or more CAM entries allocated to a microblock are being used by one or more threads as indicated by the stored logic level (e.g., logic level “1”).

After assigning a variable and a status register bit to each CAM entry, the memory manager 90 determines 96 if a thread has begun using a CAM entry. If determined that a thread has initiated use of a CAM entry such as by using the CAM entry to identify a local memory location, the memory manager 90 increments 98 the variable assigned to the CAM entry to indicate that the thread is using that CAM entry. If determined that a thread has not initiated use of a CAM entry, or after the appropriate variable has been incremented to indicate the initiated use of a CAM entry, the memory manager 90 determines 100 if a thread has stopped using a CAM entry. If a thread has stopped using a CAM entry, the memory manager 90 decrements 102 the value stored in the respective variable to reflect that one less thread is using the CAM entry associated with the variable. If determined that a thread has not stopped using a CAM entry or after a variable has been decremented to indicate use by one less thread, the memory manager 90 determines 104 if one or more of the variables associated with the CAM entries is storing a zero value. If determined that a zero value is being stored, the memory manager 90 sets 106 the respective bit in the status register to a logical level “1” to indicate that the CAM entry is not currently being used by one or more threads. If determined that the variable value is not equal to zero, or after setting the respective status register bit, the memory manager 90 returns to check if a thread has initiated use of a CAM entry.

Particular embodiments have been described, however other embodiments are within the scope of the following claims. For example, the operations of the memory manager 28 can be performed in a different order and still achieve desirable results.

1. A method comprising:
allocating a memory entry in a memory device to instructions executed on a multithreaded engine included in a packet processor, a portion of the memory entry includes a unique identifier assigned to the instructions.

2. The method of claim 1, further comprising:
maintaining a count of threads included in the multithreaded engine that use the memory entry.

3. The method of claim 1, further comprising:
maintaining a bit to represent availability of the memory entry for thread use.

4. The method of claim 2 wherein maintaining the count includes incrementing the count to represent a thread initiating use of the memory entry.

5. The method of claim 2 wherein maintaining the count includes decrementing the count to represent a thread halting use of the memory entry.

6. The method of claim 3 wherein maintaining the bit includes setting the bit to represent availability of the memory entry for thread use.

7. The method of claim 3 wherein maintaining the bit includes clearing the bit to represent unavailability of the memory entry for thread use.

8. The method of claim 3, further comprising:
checking the bit to determine the availability of the memory entry for thread use.

9. The method of claim 1 wherein the unique identifier includes four bits.

10. The method of claim 1 wherein the memory entry identifies a location in a local memory included in the multithreaded engine of the packet processor.

11. A computer program product, tangibly embodied in an information carrier, the computer program product being operable to cause a machine to:
allocate a memory entry in a memory device to instructions executed on a multithreaded engine included in a packet processor, a portion of the memory entry includes a unique identifier assigned to the instructions.

12. The computer program product of claim 11 being further operable to cause a machine to:
maintain a count of threads included in the multithreaded engine that use the memory entry.

13. The computer program product of claim 11 being further operable to cause a machine to:
maintain a bit to represent availability of the memory entry for thread use.

14. The computer program product of claim 12 wherein maintaining the count includes incrementing the count to represent a thread initiating use of the memory entry.

15. The computer program product of claim 12 wherein maintaining the count includes decrementing the count to represent a thread halting use of the memory entry.

16. The computer program product of claim 13 wherein maintaining the bit includes setting the bit to represent availability of the memory entry for thread use.

17. The computer program product of claim 13 wherein maintaining the bit includes clearing the bit to represent unavailability of the memory entry for thread use.

18. The computer program product of claim 13 being further operable to cause a machine to:
check the bit to determine the availability of the memory entry for thread use.

19. The computer program product of claim 11 wherein the unique identifier includes four bits.

20. The computer program product of claim 11 wherein the memory entry identifies a location in a local memory included in the multithreaded engine of the packet processor.

21. A memory manager comprises:
a process to allocate a memory entry in a memory device to instructions executed on a multithreaded engine included in a packet processor, a portion of the memory entry includes a unique identifier assigned to the instructions.

22. The memory manager of claim 21, further comprises:
a process to maintain a count of threads included in the multithreaded engine that use the memory entry.

23. The memory manager of claim 21, further comprises:
a process to maintain a bit to represent availability of the memory entry for thread use.

24. A system comprising:
a packet processor capable of,
allocating a memory entry in a memory device to instructions executed on a multithreaded engine included in a packet processor, a portion of the memory entry includes a unique identifier assigned to the instructions.

25. The system of claim 24 wherein the packet processor is further capable of:
maintaining a count of threads included in the multithreaded engine that use the memory entry.

26. The system of claim 24 wherein the network processor is further capable of:
maintaining a bit to represent availability of the memory entry for thread use.

27. A network forwarding device comprising:
an input port for receiving packets;
an output for delivering the received packets; and
a network processor capable of,
allocating a memory entry in a memory device to instructions executed on a multithreaded engine included in a packet processor, a portion of the memory entry includes a unique identifier assigned to the instructions.

28. The network forwarding device of claim 27, wherein the network processor is further capable of maintaining a count of threads included in the multithreaded engine that use the memory entry.

29. The network forwarding device of claim 28, wherein the network processor is further capable of maintaining a bit to represent availability of the memory entry for thread use.

30. A method comprising:
allocating a content-addressable-memory (CAM) entry to a microblock executed on a multithreaded microengine included in a network processor, a portion of the CAM entry includes a unique identifier assigned to the microblock.

31. The method of claim 30, further comprising:
maintaining a count of threads included in the multithreaded microengine that use the CAM entry.

32. The method of claim 30, further comprising:
maintaining a bit in a status register to represent availability of the CAM entry to identify a local memory location.
